(19) United States
(12) Patent Application Publication
(10) Pub. No.: US 2012/0148341 A1
(43) Pub. Date: Jun. 14, 2012

(54) DETACHABLE FASTENING DEVICE FOR SLIDING MODULE IN SLIDING-TYPE PORTABLE COMMUNICATION TERMINAL

(75) Inventors: Jeong-Il LEE, Gyeongsangbuk-do (KR); Chang-Won HUR, Busan (KR); Sung-Cherl KIM, Gyeongsangbuk-do (KR)

(73) Assignee: SAMSUNG ELECTRONICS CO., LTD., Gyeonggi-Do (KR)

(21) Appl. No.: 13/280,483

(22) Filed: Oct. 25, 2011

(30) Foreign Application Priority Data
Dec. 9, 2010 (KR) 10-2010-0125313

(51) Int. Cl. F16B 1/00

(52) U.S. Cl. 403/348

(57) ABSTRACT

A detachable fastening device of a sliding module in a sliding-type portable terminal includes: a guide member having one or more guide rails; a sliding member movable within a predetermined distance on the guide member in a state in which the sliding member is restrained to face the guide rails; and one or more swing dampers rotatably mounted at an entrance area of the guide member, the swing dampers allowing the sliding member in an assembled state to be readily disassembled, or the sliding member in a disassembled state to be readily assembled depending on whether it is swung or not.

### CLAIM OF PRIORITY

This application claims the priority under 35 U.S.C. §119 of an application entitled “Detachable Fastening Device For Sliding Module In Sliding-Type Portable Communication Terminal” filed in the Korean Intellectual Property Office on Dec. 9, 2010 and assigned Serial No. 10-2010-0125313, the contents of which are hereby incorporated by reference.

### BACKGROUND OF THE INVENTION

1. Field of the Invention

The present invention relates to a sliding-type portable terminal, and more particularly to a detachable fastening device which makes it easy to assemble or disassemble a sliding module employed in a sliding-type portable terminal.

2. Description of the Related Art

In general, a portable communication terminal refers to a cellular phone, a PDA (Personal Digital Assistant), a HHP (Hand Help Product), a smart phone, a tablet PC, or the like. Such a portable communication terminal is typically classified into a bar-type, a folder-type, or a sliding-type portable communication terminal.

Among various types of terminals, a sliding-type portable communication terminal includes a main body, a sliding-body, and a sliding module for interconnecting the main body and the sliding body. The sliding module mechanically interconnects the main body and the sliding body in such a manner that the sliding body can be manually, automatically or semi-automatically opened or closed relative to the main body. A keypad and a microphone are located on the top side of the main body, and a display unit and a speaker are typically located on the top side of the sliding body.

A conventional sliding module includes a guide member and a sliding member, wherein the guide member is coupled to the top side of the main body, and the sliding member is coupled to the bottom side of the sliding member. The sliding member is typically constructed to be slidable within a predetermined distance on the guide member.

However, conventional sliding-type portable communication terminals have drawbacks in that if it is necessary to repair a sliding module after the assembly completion, the entire sliding module must be replaced with a new one. However, a detachable fastening device for the sliding module is not separately provided most instances, and even if such a detachable fastening device is provided, much time is consumed in disassembling the sliding module from an assembled state as well assembling from a disassembled state. In lieu of replacement, reusing a sliding module is difficult as repairing is not easy especially most detachable fastening device is a single-use consumable product due to its fixed type configuration. Consequently, when repairing a product, it is frequently required to substitute the entire product with a new one which in turn increases the manufacturing costs of products.

### SUMMARY OF THE INVENTION

Accordingly, the present invention has been made to solve the above-mentioned problems occurring in the prior art, and an aspect of the present invention provides a detachable fastening device for a sliding module in a sliding-type portable communication terminal which enables convenient and quick repair of the sliding module.

Also, another aspect of the present invention provides a detachable fastening device for a sliding module which can reduce the manufacturing costs.

In accordance with an aspect of the present invention, a detachable fastening device of a sliding module in a sliding-type portable terminal includes: a guide member having one or more guide rails; a sliding member movable within a predetermined distance on the guide member in a state in which the sliding member is restrained to face the guide rails; and one or more swing dampers rotatably mounted at an entrance area of the guide member, the swing dampers allowing the sliding member in an assembled state to be readily disassembled, or the sliding member in a disassembled state to be readily assembled depending on whether it is swung or not.

In accordance with an aspect of the present invention, a detachable fastening device of a sliding module in a sliding-type portable terminal includes: a guide member having one or more guide rails; a sliding member slidably mountable to the guide member; and one or more swing dampers rotatably mounted at an entrance area of the guide member to provide the sliding member in an assembled state or disassembled state to or from the guide member.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view showing a sliding module which employs the inventive detachable fastening device;

FIG. 2 is a perspective view showing the inventive detachable fastening device before its first swing damper is swung;

FIG. 3 is a perspective view showing the inventive detachable fastening device after its first swing damper is swung;

FIG. 4 is a perspective view showing a state in which a sliding member is separated from a guide member of the inventive detachable fastening device;

FIG. 5 is a perspective view showing a state in which the sliding member is coupled to the guide member after the first and second swing dampers of the inventive detachable fastening device are swung about 180 degrees; and

FIG. 6 is a perspective view showing a state in which the sliding member cannot escape from the guide member since the first and second swing dampers of the inventive detachable fastening device are received in first and second receiving recesses, respectively.

### DETAILED DESCRIPTION

Hereinafter, the construction of a detachable fastening device for a sliding module in a sliding-type portable communication terminal according to embodiments of the present invention will be described with reference to the accompanying drawings. In the following description, the same elements will be designated by the same reference numerals although they are shown in different drawings.

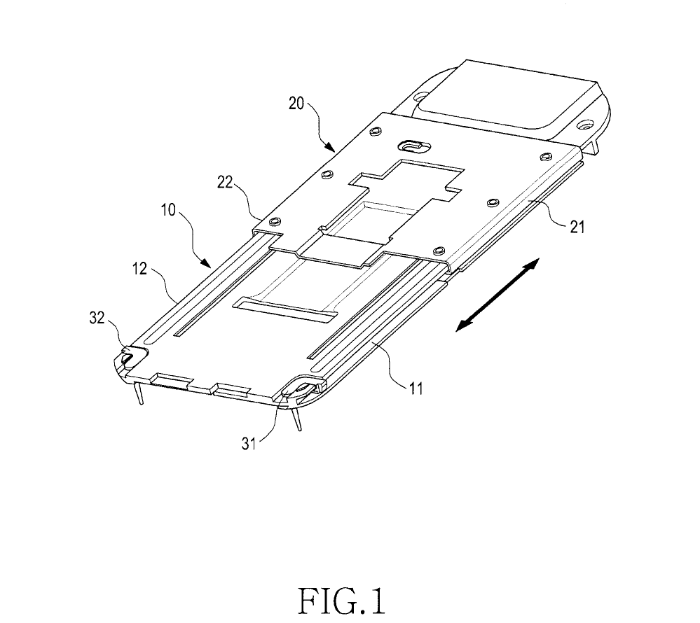

FIG. 1 is a perspective view showing a sliding module which employs the inventive detachable fastening device. As shown in FIG. 1, the inventive detachable fastening device includes a guide member 10, a sliding member 20, and first and second swing dampers 31 and 32. The guide member 10 is coupled to the top side of a body, i.e., a first body of the terminal (not shown), and the sliding member 20 is coupled to the bottom side of a sliding body, i.e., a second body of the terminal (not shown). The sliding member 20 is restrained in a state in which it faces the guide member 10, and conducts linear reciprocating sliding movements along the guide member 10 within a predetermined distance. Since the guide member 10 has first and second guide rails 11 and 12 at its opposite longitudinal edges, the sliding member 20 has first and second guides 21 and 22 at its opposite longitudinal edges, which are slidably coupled to the first and second guide rails 11 and 12, respectively. Thus, the sliding member 20 conducts sliding movements in a state in which it is restrained by the guide member 10 and stably faces the guide member 10.

The first and second swing dampers 31 and 32 are symmetrically arranged at the entrance area of the guide member 10. Since the construction of the swing dampers 31 and 32 are the same, a description thereof will be made only with reference to the first swing damper 31 to avoid redundancy.

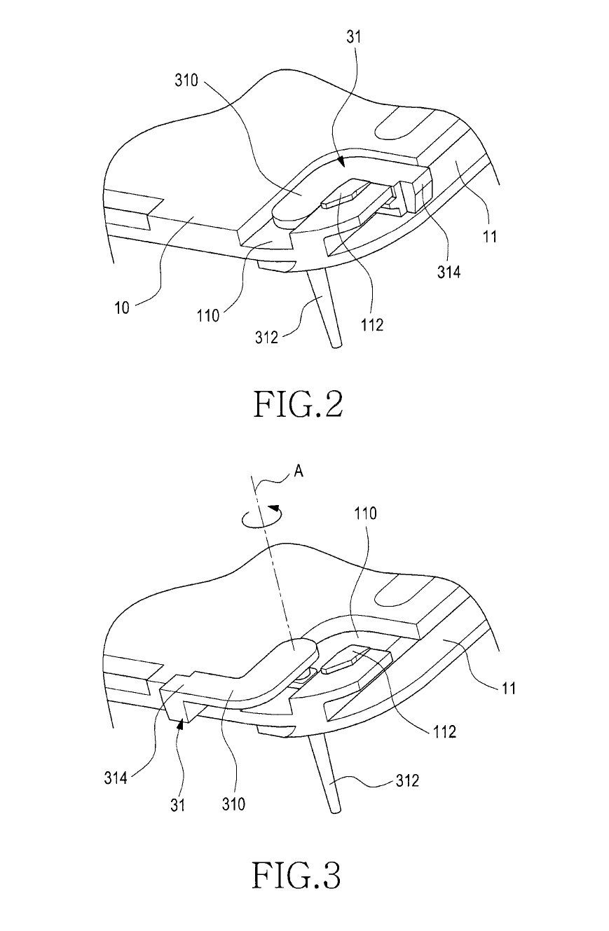

As shown in FIGS. 2 and 3, the first swing damper 31 is mounted to be capable of swinging about a rotary axis A at the entrance area of the guide member 10. The first swing damper 31 is formed from a flexible material with high elasticity, for example, a rubber or silicone material. The first swing damper 31 allows the sliding member 20 (see FIG. 1) to be readily disassembled from the guide member 10 when the sliding member 20 is in the assembled state, or can be readily assembled to the guide member 10 when the sliding member is in the disassembled state.

Now, the construction of the first swing damper 31 will be described in more detail.

The first swing damper 31 includes a first rotation restraint portion 312 and a first swing body 310. The first rotation restraint portion 312 is fastened to the entrance area in the direction perpendicular to the sliding direction of the sliding member, and is fastened by interference fit. The first swing body 310 extends integrally with the first rotation restraint portion 312 and has its one end protruding to the first guide rail 11.

Referring to FIG. 2, if the first swing damper 31 is in a state in which it is received in the entrance area, the end 314 of the first swing damper 31 is arranged to protrude to the first guide rail 11, thereby serving as a stopper for the sliding member 20 (see FIG. 1), thus preventing the escape of the sliding member 20. Referring to FIG. 3, if the first swing damper 31 is in a state in which it is swung to a predetermined angle from the entrance area, the end 314 escapes from the first guide rail 11, thereby allowing the sliding member 20 to escape from the guide member 10.

As shown in FIGS. 1 to 3, the entrance area which corresponds to the opposite corners of the guide member 10 includes a first receiving recess 110 corresponding to the first swing body 310. That is, prior to the swinging of the first swing damper 31, the first swing body 310 is arranged to be fully received in the first receiving recess 110. Then, if the first swing damper 31 is swung by a predetermined angle, the first swing body 310 leaves the first receiving recess 110.

In addition, the entrance area is provided with a first inclined protrusion 112 which helps the swing action of the first body 31. As the first swing damper 31 is released, the first protrusion 112 guides the first swing damper 31 to be swung about 180 degrees. During the swing action of the first swing damper 31, the first protrusion 112 does not obstruct the swing action of the first swing body 310 as the first swing body 310 escapes from the first receiving recess 110.

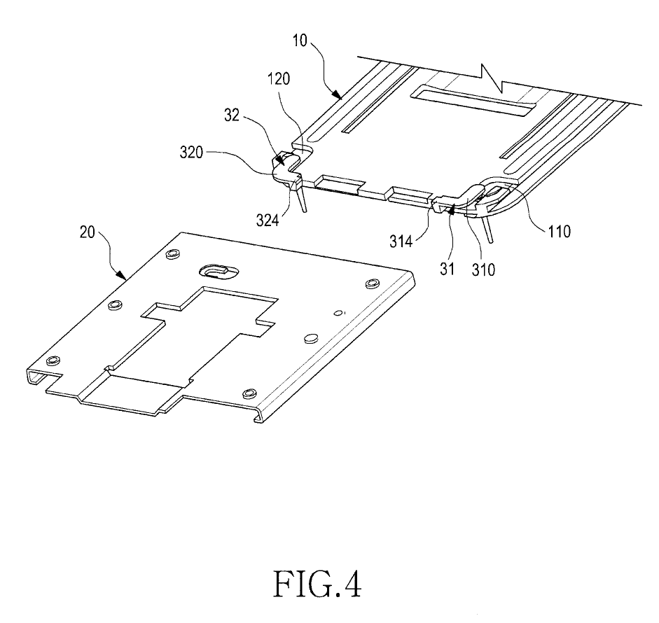

Now, description will be made as to how the sliding member 20 is disassembled from its assembled state or assembled from its disassembled state depending on whether the first and second swing dampers 31 and 32 are swung or not, with reference to FIGS. 4 to 7.

FIG. 4 is a perspective view showing a state in which the sliding member 20 is removed from the guide member 10. As shown in FIG. 4, the first and second swing dampers 31 and 32 are swung about 180 degrees so that the sliding member 20 can be slidably fit to the guide member 10.

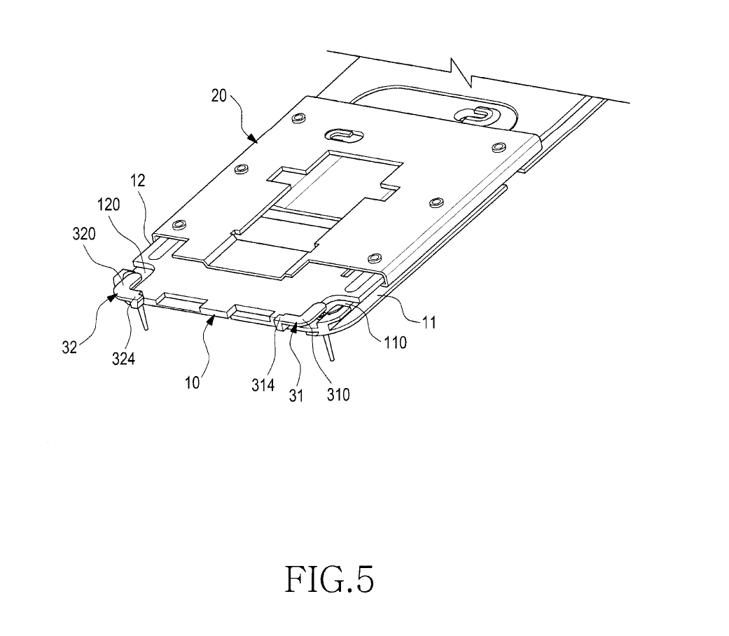

FIG. 5 is a perspective view showing a state in which the sliding member 20 is slidably coupled to the guide member 10 after the first and second swing dampers 31 and 32 were swung about 180 degrees. The sliding member 20 is arranged on the guide member 10 by assembling the sliding member 20 along the first and second guide rails 11 and 12.

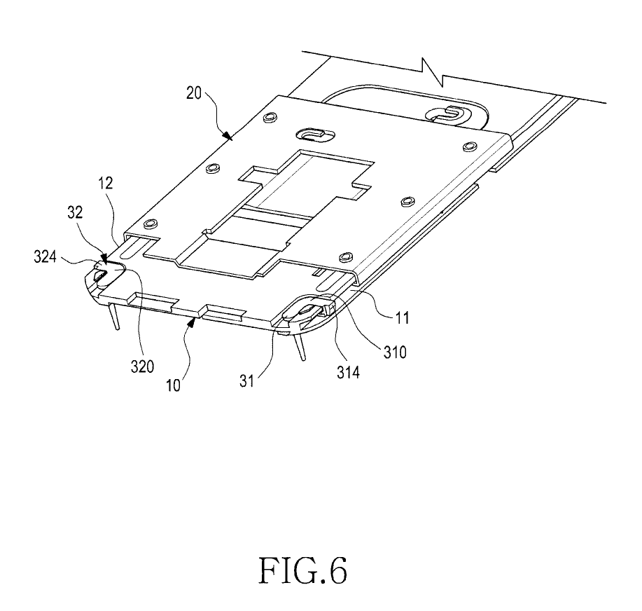

FIG. 6 is a perspective view showing a state in which the sliding member 20 cannot escape from the guide member since the first and second swing dampers 31 and 32 are received in the first and second receiving recesses 110 and 120, respectively. As shown in FIG. 6, if the first and second swing dampers 31 and 132 are reversely swung about 180 degrees and then pushed, the first and second swing dampers 31 and 32 are fully received in the first and second receiving recesses 110 and 120, respectively. At this time, the ends 314 and 324 of the first and second swing dampers are positioned to protrude to the first and second guide rails 11 and 12, respectively, thus the sliding member 20 cannot escape from the guide member 10.

Accordingly, by engaging the first and second swing members 31 and 32 from lock and unlock position, the sliding member 20 can be readily disassembled from its assembled state, or assembled from its disassembled state. The sliding member 20 can be prevented from escaping completely from the guide member 10 with the aid of the ends 314 and 324 of the first and second swing members serving as stoppers for the sliding member 20.

As described above, since the present invention allows a sliding module of a sliding-type portable communication terminal in an assembled state to be readily disassembled, or the sliding module in a disassembled to be readily assembled, it is convenient to conduct repairs of such a sliding module. As mentioned earlier, the easiness of repairing the sliding module can contribute to the reduction of the manufacturing costs when compared to the prior art.

While the invention has been shown and described with reference to certain embodiments thereof, it will be understood by those skilled in the art that various changes in form and details may be made therein without departing from the spirit and scope of the invention as defined by the appended claims.

What is claimed is:

1. A detachable fastening device of a sliding module in a sliding-type portable terminal, comprising:
a guide member having one or more guide rails;
a sliding member movable within a predetermined distance on the guide member in a state in which the sliding member is restrained to face the guide rails; and
one or more swing dampers rotatably mounted at an entrance area of the guide member, the swing dampers allowing the sliding member in an assembled state to be readily assembled and disassembled from the guide member.

2. The detachable fastening device as claimed in claim 1, wherein the swing dampers are formed from a flexible material.

3. The detachable fastening device as claimed in claim 1, wherein each of the swing dampers comprises:
a rotation restraint portion coupled to the entrance area in a direction perpendicular to the sliding direction; and
a swing body extending integrally with the rotation restraint portion, wherein if the swing body is received in the entrance area, one end of the swing body is arranged to protrude to the guide rail, and if the swing body is swung from the entrance area, the one end of the swing body escapes from the guide rail to allow the sliding member to be removed.

4. The detachable fastening device as claimed in claim 3, wherein the entrance area corresponds to the corners of the guide member, the entrance having a receiving recess to accommodate the swing body.

5. The detachable fastening device as claimed in claim 3, wherein the entrance area further comprises an inclined protrusion for helping the swing action of the swing body.

6. The detachable fastening device as claimed in claim 1, wherein the swing dampers are symmetrically arranged on the entrance area.

7. The detachable fastening device as claimed in claim 3, wherein the swing body is comprises a curved shape.

8. A detachable fastening device of a sliding module in a sliding-type portable terminal, comprising:
a guide member having one or more guide rails;
a sliding member slidably mountable to the guide member; and
one or more swing dampers rotatably mounted at an entrance area of the guide member to provide the sliding member in an assembled state or disassembled state to or from the guide member.

9. The detachable fastening device as claimed in claim 8, wherein the swing dampers are formed from a flexible material.

10. The detachable fastening device as claimed in claim 1, wherein each of the swing dampers comprises:
a rotation restraint portion coupled to the entrance area in a direction perpendicular to the sliding direction; and
a swing body extending integrally with the rotation restraint portion, wherein if the swing body is received in the entrance area, an end of the swing body is arranged to protrude to the guide rail to maintain the assembled state, and if the swing body is leaves from the entrance area, the one end of the swing body escapes from the guide rail to allow the sliding member to be removed from the guide member.

11. The detachable fastening device as claimed in claim 10, wherein the entrance area further comprises an inclined protrusion for helping the swing action of the swing body.

12. The detachable fastening device as claimed in claim 8, wherein the swing dampers are symmetrically arranged on the entrance area.

13. The detachable fastening device as claimed in claim 8, wherein the swing body comprises a curved shape.

14. The detachable fastening device as claimed in claim 8, wherein the guide member is adoptively coupled to a first body of the portable terminal.

15. The detachable fastening device as claimed in claim 8, wherein the sliding member movable is adoptively coupled to a second body of the portable terminal.
